(19) United States
(12) Patent Application Publication
(10) Pub. No.: US 2021/0057687 A1
(43) Pub. Date: Feb. 25, 2021

(54) BATTERY DEVICE AND MANUFACTURING METHOD

(71) Applicant: KABUSHIKI KAISHA TOSHIBA, Minato-ku (JP)

(72) Inventors: Tatsumi MATSUO, Kokubunji (JP); Hirofumi YAMAMOYO, Saitama (JP); Takashi ENOMOTO, Fuchu (JP)

(73) Assignee: KABUSHIKI KAISHA TOSHIBA, Minato-ku (JP)

(21) Appl. No.: 16/965,479

(22) PCT Filed: Jan. 30, 2018
(86) PCT No.: PCT/JP2018/002872

§ 371 Date: Jul. 28, 2020

(51) Int. Cl. H01M 2/10

(52) U.S. Cl. CPC H01M 2/1061; H01M 2/1077

(57) ABSTRACT

A battery device includes a battery cell; an exterior member that accommodates the battery cell; and one or more foamed resin fixing members disposed between the battery cell and the exterior member. The foamed resin fixing members are formed of a foamed resin having self-adhesiveness.

### TECHNICAL FIELD

Embodiments of the present invention relate to a battery device and a manufacturing method.

### BACKGROUND ART

Conventionally, battery pack devices including laminated battery cells with a molded resin member held therebetween have been developed.

Such a laminated battery pack device, if having a large number of layers, may be configured to prevent accumulated error due to the lamination. For that purpose, the outer casing of the battery cells is partly pressed into a resin pack housing or the outer casing of the battery cells additionally includes an elastic resin or metal and is fixed to the resin pack housing while applied with pressure.

### CITATION LIST

### Patent Literature

Patent Document 1: Japanese Laid-open Patent Application Publication No. 2011-023296

### SUMMARY OF INVENTION

### Problem to be Solved by the Invention

However, such a conventional battery pack device is adversely complexed in configuration and lowered in volumetric efficiency, and an elastic resin or metal is to be secured with an adhesive or adhesive tape, for example.

Further, an increased number of parts and components may cause difficulty in ensuring a cooling air passage for efficiently dissipating the heat of the battery cells and maintaining the capacity of the battery cells.

In view of the above, an object of the present invention is to provide a battery device and a manufacturing method that can simplify a device configuration, prevent decrease in volumetric efficiency, and easily ensure a cooling passage.

### Means for Solving Problem

According to one embodiment, a battery device includes a battery cell, an exterior member that can accommodate the battery cell, and a foamed resin fixing member formed of a foamed resin having self-adhesiveness, and disposed between the battery cell and the exterior member.

### BRIEF DESCRIPTION OF DRAWINGS

FIG. 1 illustrates a battery unit according to an embodiment;

FIG. 2 illustrates assembly of the battery unit in the embodiment;

FIG. 3 illustrates a battery unit according to a first aspect of a second embodiment;

FIG. 4 illustrates a battery unit according to a second aspect of the second embodiment;

FIG. 5 illustrates a battery unit according to a third aspect of the second embodiment;

FIG. 6 illustrates a battery unit according to a fourth aspect of the second embodiment;

FIG. 7 illustrates a battery unit according to a fifth aspect of the second embodiment;

FIG. 8 illustrates a first aspect of a third embodiment;

FIG. 9 illustrates a second aspect of the third embodiment; and

FIG. 10 illustrates an example of a fourth embodiment.

### DESCRIPTION OF EMBODIMENTS

The following will describe preferred embodiments with reference to the accompanying drawings.

### [1]First Embodiment

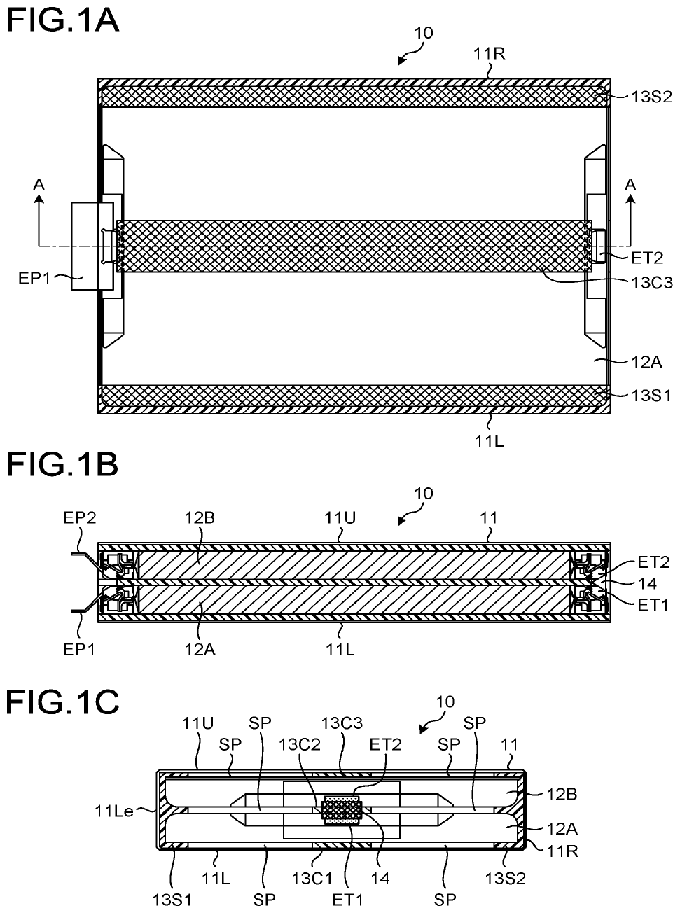

FIG. 1 illustrates a battery unit according to an embodiment.

FIG. 1(a) is a partial plan view of a section of the battery unit; FIG. 1(b) is a sectional view of the battery unit taken along the arrow A-A; and FIG. 1(c) is a side view of the battery unit.

For the sake of better understanding, FIG. 1 depicts, as an example of a battery device (battery pack device), a battery unit including two battery cells placed on the top of each other.

A battery unit 10 includes an exterior member 11 made of stainless steel (e.g., SUS-304), a pair of battery cells 12A and 12B contained in the exterior member 11, and foamed resin fixing members 13C1, 13C2, 13C3, 13S1, and 13S2 that serve to securely hold the battery cells 12A and 12B inside the exterior member 11.

As configured above, the exterior member 11 has a tubular shape formed by metal sheet welding.

The battery cell 12A is provided at one end with an electrode panel EP1 having a plate shape which protrudes from the exterior member 11. The electrode panel EP1 is connected to an anode of a battery cell body 12A1, for example. The battery cell 12A is provided at the other end with an electrode terminal ET1 contained in the exterior member 11. The electrode terminal ET1 is connected to a cathode of the battery cell body 12A1, for example.

The battery cell 12B is provided at one end with an electrode panel EP2 having a plate shape which protrudes from the exterior member 11. The electrode panel EP2 is connected to a cathode of a battery cell body 12B1, for example. The battery cell 12B is provided at the other end with an electrode terminal ET2 contained in the exterior member 11. The electrode terminal ET2 is connected to an anode of the battery cell body 12B1, for example.

The electrode terminal ET1 of the battery cell 12A is electrically connected to the electrode terminal ET2 of the battery cell 12B via a conductive member 14 having a wedge shape. The battery cells 12A and 12B are connected in series and can output a given voltage.

Each of the battery cells 12A and 12B includes, for example, a lithium-ion secondary battery. The lithium-ion secondary battery is a kind of non-aqueous electrolyte secondary batteries, and contains lithium ions that conduct electricity in an electrolyte. Examples of a material of the anode include lithium-manganese composite oxides, lithium-nickel composite oxides, lithium-cobalt composite oxides, lithium-nickel-cobalt composite oxides, lithium-manganese-cobalt composite oxides, spinel-type lithium-manganese-nickel composite oxides, and lithium-phosphorus oxides of an olivine structure. Examples of a material of the cathode include oxide-based materials such as lithium titanate (LTO) and oxide materials such as niobium composite oxides. Examples of the electrolyte (e.g., electrolyte solution) include sole or a mixture of organic solvents, such as ethylene carbonate, propylene carbonate, diethyl carbonate, ethyl methyl carbonate, or dimethyl carbonate that contain lithium salt such as a fluorine-based complex salt (e.g., LiBF₄ or LiPF₆).

The housing of the battery cells 12A and 12B has a thin, flat, and cuboid shape (a tubular shape with a rectangular cross-section) and is made of, for example, SUS304 having a relatively thin thickness.

The battery cells 12A and 12B may be any other secondary batteries, such as nickel-hydrogen batteries or nickel-cadmium batteries. The battery cells 12A and 12B are also referred to as electric cells, for example.

The foamed resin fixing member 13C1 is located at a position corresponding to a longitudinal center of the battery cell 12A and a lower surface 11L of the exterior member 11. The foamed resin fixing member 13C2 is located at a position corresponding to a longitudinal center of the battery cells 12A and 12B and between the battery cells 12A and 12B. The foamed resin fixing member 13C3 is located at a position corresponding to a longitudinal center of the battery cell 12B and an upper surface 11U of the exterior member 11.

The foamed resin fixing members 13S1 and 13S2 are located at respective positions corresponding to both side surfaces of the battery cells 12A and 12B and corresponding to a left side surface 11L and a right side surface 11R of the exterior member 11. Each of the foamed resin fixing members 13S1 and 13S2 has an E-shaped cross-section, and the foamed resin fixing members 13S1 and 13S2 are partially located between the upper surface 11U of the exterior member 11 and the battery cell 12B, between the battery cells 12A and 12B, and between the lower surface 11L of the exterior member and the battery cell 12A, to maintain cooling spaces SP.

As configured above, a material of the foamed resin fixing members 13C1, 13C2, 13C3, 13S1, and 13S2 includes, for example, a two-component reaction curing, foamed urethane resin.

Specifically, examples of the foamed urethane resin include an HYU foam (ultra-high humidity urethane foam produced by Hattori-shoten Co., Ltd.); insulpak (registered trademark) (simple urethane foam produced by ABC Trading Co., Ltd.); and Cellasto (registered trademark) (urethane foam elastomer produced by BASF INOAC Polyurethanes Ltd.).

In the above description, a foamed resin forming member is exemplified by a foamed urethane resin; it is however, not limited thereto. Any resin may be used as long as it has self-adhesiveness and effervescence.

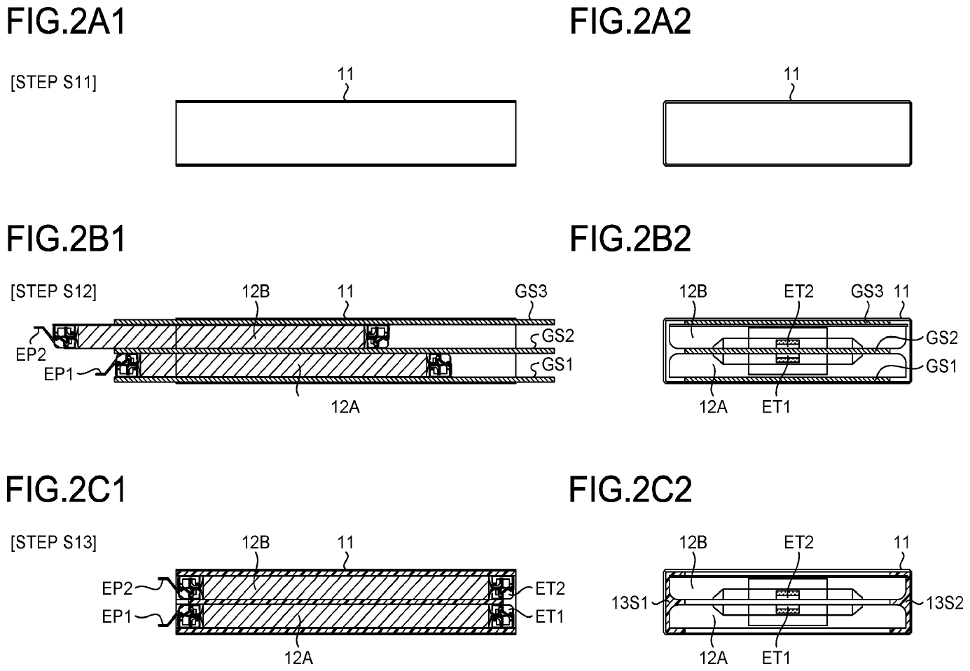

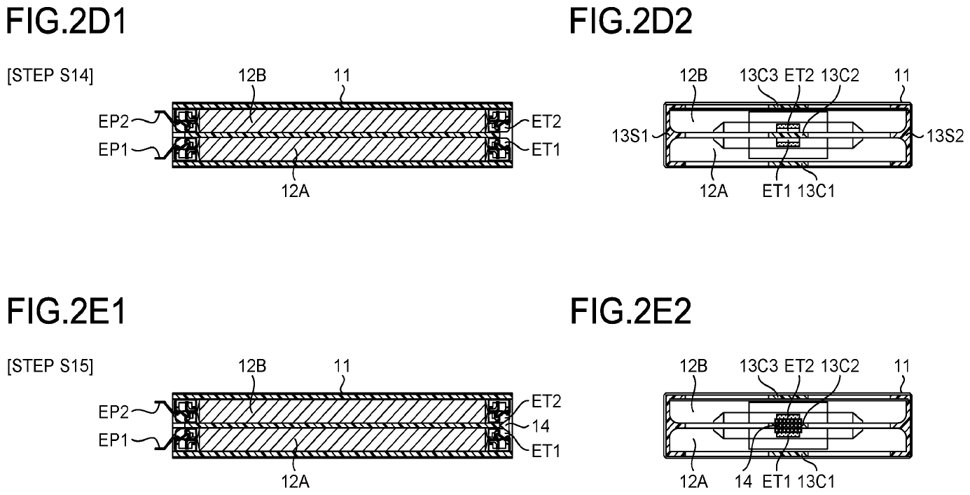

FIG. 2 illustrates assembly of the battery unit in the embodiment.

First, the exterior member 11 is prepared (Step S11).

Then, a first guide spacer GS1 is placed so as to protrude from both sides of the exterior member 11 via apertures, the battery cell 12A is mounted, and a second guide spacer GS2 is mounted on the upper surface (upward in FIG. 2) of the battery cell 12A. Next, the battery cell 12B is mounted on the guide spacer GS2 such that the battery cell 12B faces the battery cell 12A and the electrode terminal ET1 of the battery cell 12A opposes the electrode terminal ET2 of the battery cell 12B. Then, a third guide spacer GS3 is mounted on the upper surface (upward in FIG. 2) of the battery cell 12B. The battery cells 12A and 12B except for the electrode panels EP1 and EP2 are now contained in the exterior member 11 (step S12).

The foamed resin is injected with a resin injection nozzle (not illustrated) into lateral spaces having an E-shaped cross-section formed between the exterior member 11 and each of the guide spacers GS1 to GS3 and between the battery cells 12A and 12B. Thereby, the foamed resin fixing members 13S1 and 13S2 are formed (step S13).

After the foamed resin fixing members 13S1 and 13S2 are completely cured, the guide spacers GS1 to GS3 are removed. Then, the foamed resin is injected with a resin injection nozzle (not illustrated) into the spaces corresponding to the foamed resin fixing members 13C1, 13C2, and 13C3. Thereby, the foamed resin fixing members 13C1, 13C2, and 13C3 are formed (step S14).

In this case, the resin injection nozzle is moved inside (pulled out from) the spaces formed from the removal of the guide spacers GS1 to GS3, to individually form the foamed resin fixing members 13C1, 13C2, and 13C3.

Subsequently, the wedge-shaped conductive member 14 is welded to both the electrode terminal ET1 of the battery cell 12A and the electrode terminal ET2 of the battery cell 12B. Thereby, the battery cell 12A is welded to the battery cell 12B and electrically connected thereto in series (step S15).

As a result, the battery unit including two battery cells is formed.

As configured above, the foamed resin fixing members 13S1, 13S, 13C1, 13C2, and 13C3 include hard urethane foam. Because of its self-adhesiveness, the hard urethane foam can adhere firmly to the surface of an intended object included in the exterior member 11, such as a metal or plyboard, without use of an adhesive.

Hardness of the hard urethane foam is controllable to some extent by controlling an expansion ratio of the hard urethane foam. It is thus made possible to design a battery unit that focuses more on either a vibration absorbing capacity or a shape maintaining capacity (load bearing capacity).

The battery unit 10 in the first embodiment can be simplified in configuration and ensure quake resistance and impact resistance. In this case, the battery unit 10 can prevent decrease in volumetric efficiency and easily ensure a cooling passage.

Since the fixing members are formed of foamed resin and cured in gaps, the fixing members are adoptable to various shapes of exterior members and battery cells and to various specifications, as opposed to molded components.

### [2]Second Embodiment

The first embodiment has described the battery cells having a length-width ratio set to about 2 to 1. In a second embodiment the length-width ratio of the battery cells is set to about 4 to 1 in order to increase battery capacity and decrease thickness. That is, the length of an exterior member is increased. Thus, the second embodiment is intended to ensure a cooling passage in laminated battery cells.

[2.1] First Aspect

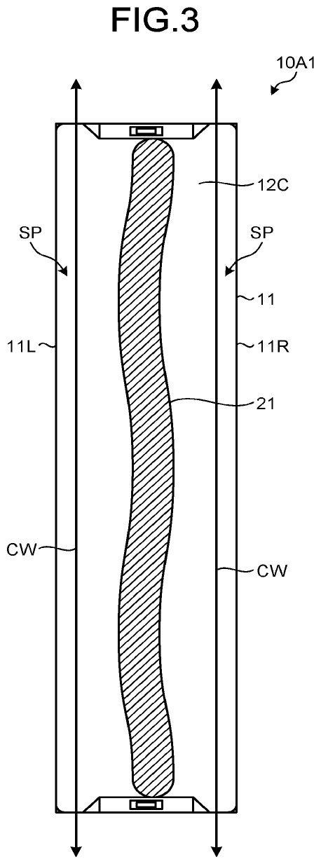

FIG. 3 illustrates a battery unit according to a first aspect of the second embodiment.

In FIG. 3, the same or like elements are denoted by the same reference numerals as those in FIG. 1.

For the sake of better understanding, FIG. 3 depicts a battery cell 12C alone, with the upper surface 11U of the exterior member 11 and a battery cell mounted on the upper surface 11U removed.

A battery unit 10A1 in the first aspect of the second embodiment includes a foamed resin fixing member 21 in a meandering strip form within a gap between battery cells in a laminated direction of the battery cells.

Such a foamed resin fixing member 21 can form, on both lateral sides, spaces SP that define cooling passages. The cooling passages can create flows CW of cooling air, serving to efficiently cool the battery cell 12C. Thereby, the battery unit 10A1 can efficiently operate.

[2.2] Second Aspect

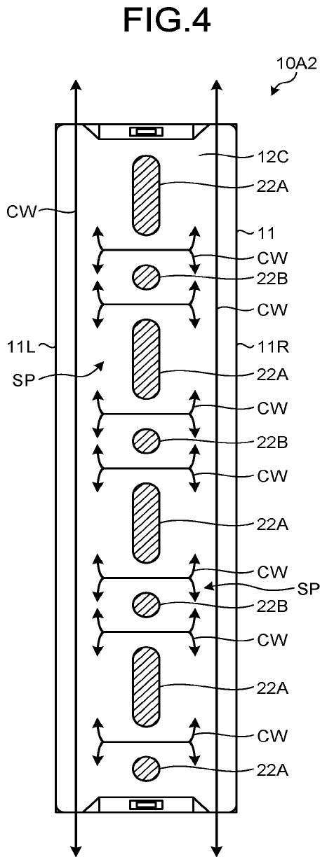

FIG. 4 illustrates a battery unit according to a second aspect of the second embodiment.

In FIG. 4, the same or like elements are denoted by the same reference numerals as those in in FIG. 3.

For the sake of better understanding, FIG. 4 depicts the battery cell 12C alone, with the upper surface 11U of the exterior member 11 and a battery cell mounted on the upper surface 11U removed, as with FIG. 3.

The first aspect of the second embodiment has described the foamed resin fixing member in a meandering strip form. A battery unit 10A2 in the second aspect includes a plurality of foamed resin fixing members 22A and 22B aligned in a row in a dot (circular or elliptical) form within a gap between battery cells in a laminated direction of the battery cells.

The foamed resin fixing members 22A and 22B serve to form, on both lateral sides, spaces SP that define cooling passages. These cooling passages can create flows CW of cooling air between the foamed resin fixing members 22A and 22B in addition to the flows CW of cooling air on both lateral sides of the foamed resin fixing member 21. The battery cell 12C is thereby efficiently cooled so that the battery unit 10A2 can operate efficiently.

[2.3] Third Aspect

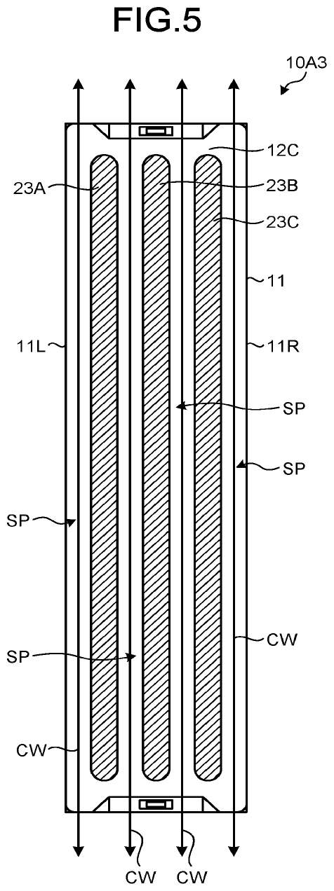

FIG. 5 illustrates a battery unit according to a third aspect of the second embodiment.

The first aspect of the second embodiment has described the foamed resin fixing member of a meandering strip form aligned in a row. A battery unit 10A3 in a third aspect includes foamed resin fixing members of a straight strip form arranged in a plurality of (three in the example of FIG. 5) rows within a gap between battery cells in the laminated direction of the battery cells.

That is, foamed resin fixing members 23A to 23C of a straight strip form are disposed.

The foamed resin fixing members 23A to 23C can form, on both lateral sides of the foamed resin fixing member 23A and the foamed resin fixing member 23C, spaces SP that define cooling passages. These cooling passages can create flows CW of cooling air. The battery cell 12C is thereby cooled efficiently so that the battery unit 10A3 can operate efficiently.

Moreover, the foamed resin fixing members in multiple rows are fixed by bonding and can thus improve stiffness.

[2.4] Fourth Aspect

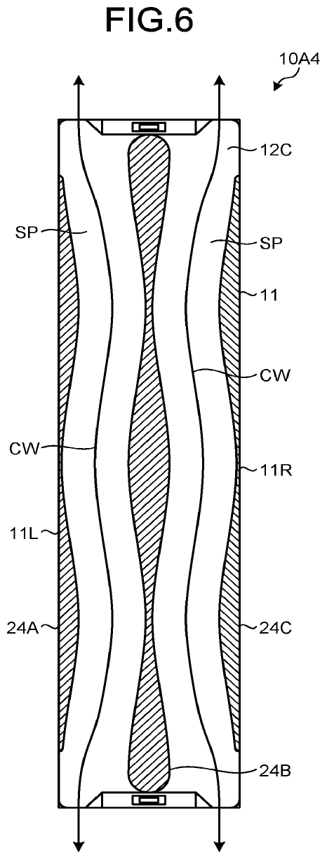

FIG. 6 illustrates a battery unit according to a fourth aspect of the second embodiment.

The first and third aspects of the second embodiment have described the independent foamed resin fixing members having a uniform width (a length in a direction orthogonal to the longitudinal direction). A battery unit 10A4 in the fourth aspect includes foamed resin fixing members 24A to 24C with periodically varying widths depending on the longitudinal position.

Such foamed resin fixing members 24A to 24C can form, on both lateral sides of the foamed resin fixing member 24B, spaces SP that define cooling passages. These cooling passages can create meandering flows CW of cooling air. The battery cell 12C is thereby cooled efficiently so that the battery unit 10A4 can operate efficiently.

As in the third aspect, the foamed resin fixing members in multiple rows are fixed by bonding and can thus improve stiffness.

[2.5] Fifth Aspect

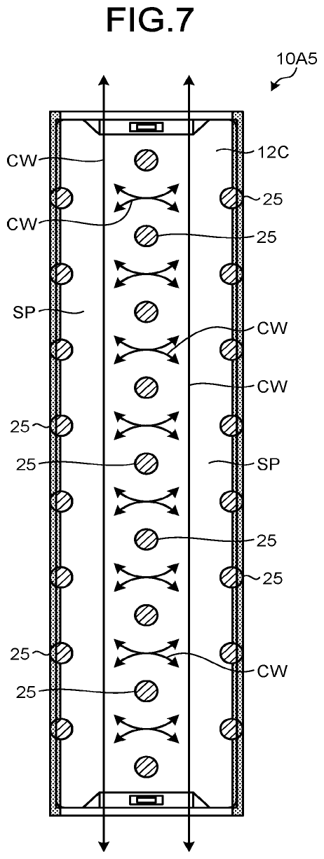

FIG. 7 illustrates a battery unit according to a fifth aspect of the second embodiment.

The second aspect has described the foamed resin fixing members of a dot form arranged on a straight line. A battery unit 10A5 in the fifth aspect includes foamed resin fixing members 25 of a dot form arranged in a staggered and distributed manner.

According to the fifth aspect, the battery unit can ensure its mechanical strength and ensure cooling efficiency through the cooling air passages reliably formed throughout the upper and lower surfaces of each battery cell.

### [3] Third Embodiment

The above embodiments have not considered resonance of each battery cell. In a third embodiment, foamed resin fixing members are disposed in consideration of first-order to third-order bending modes as to the resonances of battery cells.

[3.1] First Aspect

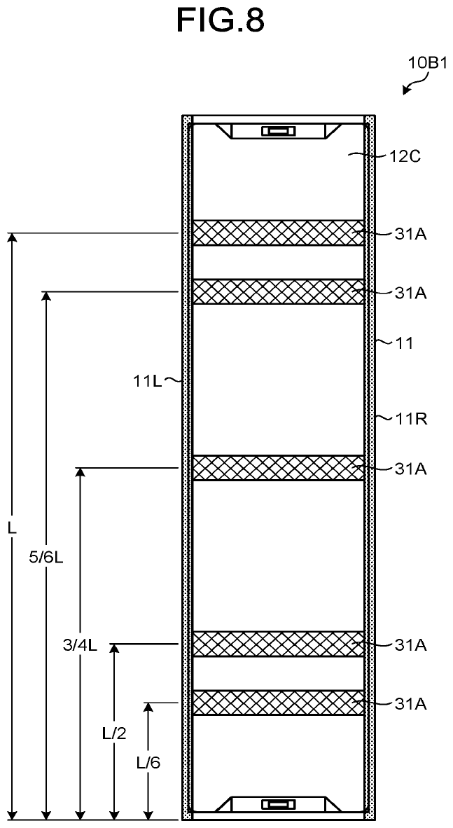

FIG. 8 illustrates a first aspect of a third embodiment.

As illustrated in FIG. 8, the longitudinal length of a battery cell is defined to be L. Foamed resin fixing members 31A are disposed in parallel to one another to fully extend in the lateral direction of the battery cell at an L/2 position, at L/4 and 3×L/4 positions, and at L/6, 3×L/6, and 5×L/6 positions. The L/2 position is regarded as an antinode of a vibration in a first-order bending mode (at a position at ½ length of the battery cell). The L/4 and 3×L/4 positions are regarded as antinodes of vibrations in a second-order bending mode (at positions at ¼ length of the battery cell from both longitudinal sides). The L/6, 3×L/6, and 5×L/6 positions are regarded as antinodes of vibrations in a third-order bending mode.

Disposing the foamed resin fixing member 31A in this manner can suppress the vibrations of the battery cell 12C due to resonance and improve the stiffness of a battery unit 10B1 as a whole.

[3.2] Second Aspect

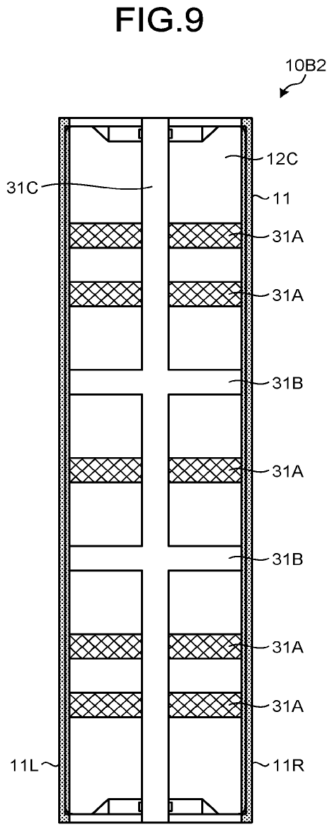

FIG. 9 illustrates a second aspect of the third embodiment.

To suppress vibrations that cannot be suppressed by the first aspect, a battery unit 10B2 includes foamed resin fixing members 31B that suppress the vibrations between antinodes of vibrations in the first-order and second-order bending modes, and a foamed resin fixing member 31C at a longitudinal center extending over the entire longitudinal length, in addition to the elements in the first aspect of the third embodiment.

This structure can further suppress vibrations and improve stiffness.

### [4] Fourth Embodiment

The above embodiments have described the maximum number of battery cells set to two. A fourth embodiment concerns the number of laminations of battery cells set to three or more.

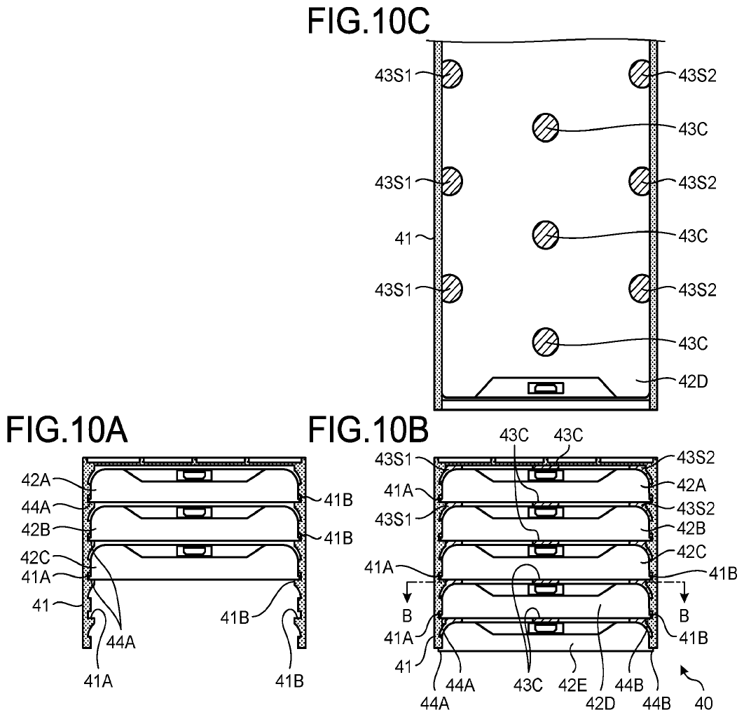

FIG. 10 illustrates an example of a fourth embodiment.

FIG. 10 depicts five stacked battery cells.

FIG. 10(a) illustrates battery cells constituting a battery unit in the course of lamination; FIG. 10(b) is a side view of the battery unit; and FIG. 10(c) is a sectional view of FIG. 10(b) taken along the arrow B-B.

As illustrated in FIG. 10(b), a battery unit 40 includes an exterior member 41 made of resin; five battery cells 42A to 42E contained in the exterior member 41; and a plurality of foamed resin fixing members 43C, 43S1, and 43S2 that securely holds the battery cells 42A to 42E inside the exterior member 41.

As configured above, the exterior member 41 has a substantially C-shaped cross-section. The inner surface of the exterior member 41 is provided with holding grooves 41A and 41B into which flanges 44A and 44B, extending in the longitudinal direction of the battery cells 42A to 42E, are slid and inserted. The holding grooves 41A can individually support the battery cells 42A to 42E.

In this case, the positions of the holding grooves 41A and 41B are set in the exterior member 41 such that the opposing surfaces of the battery cells are spaced apart from each other by a given distance to form a gap, when the battery cells 42A to 42E are inserted in the holding grooves 41A and 41B.

Between the exterior member 41 and each of the battery cells 42A to 42E, a plurality of foamed resin fixing members 43S1 and 43S2 is arranged separately from one another. Between the topmost battery cell 42A and the exterior member 41, a plurality of foamed resin fixing members 43C is formed separately from each other.

A plurality of foamed resin fixing members 43C is also formed separately between the battery cells 42A and 42B, between the battery cells 42B and 42C, between the battery cells 42C and 42D, and between the battery cells 42D and 42E.

According to the fourth embodiment, thus, the battery cells laminated in a large number of layers can ensure their mechanical strength to attain quake resistance and impact resistance, and ensure cooling efficiency through the cooling air passages reliably formed throughout the upper and lower surfaces of each battery cell.

The above has described the example of setting the number of battery-cell laminations to five. In the case of further increasing the number of laminations, the foamed resin fixing members in lower layers can be set higher in hardness than the foamed resin fixing members in upper layers (i.e., expansion ratio is set lower) to increase the mechanical strength.

Likewise, in the case of laminating two or more battery units 40, the foamed resin fixing members of a battery unit 40 in lower layers can be set higher in hardness than the foamed resin fixing members in upper layers.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A battery device comprising:
a battery cell;
an exterior member that accommodates the battery cell; and
one or more foamed resin fixing members formed of a foamed resin having self-adhesiveness, and disposed between the battery cell and the exterior member.

2. The battery device according to claim 1, further comprising:
a plurality of battery cells, wherein
the foamed resin fixing members are disposed between one of the battery cells and another one of the battery cells and between the exterior member and the battery cells.

3. The battery device according to claim 2, wherein
the battery cells are laminated on each other, and
a hardness of the foamed resin fixing members are set depending on the number of laminated battery cells.

4. The battery device according to claim 2, wherein
the battery cells are laminated on each other, and
a hardness of the foamed resin fixing members is set depending on a laminated position of a corresponding one of the battery cells.

5. The battery device according to claim 1, wherein
the foamed resin fixing members are disposed at a position corresponding to an antinode of a vibration in an n-^{th} order bending mode of the battery cell where n is a natural number.

6. The battery device according to claim 1, wherein
the foamed resin fixing members are arranged in a strip form, in a dot form, or in a staggered form.

7. The battery device according to claim 1, wherein
the foamed resin fixing members each have a strip form with a width varying in a longitudinal direction of the foamed resin fixing member.

8. The battery device according to claim 1, wherein
a location inside the exterior member where the foamed resin fixing members are not disposed forms a cooling air passage.

9. A manufacturing method of a battery device, the battery device comprising a battery cell and an exterior member that accommodates the battery cell, the manufacturing method comprising:
holding the battery cell inside the exterior member in such a manner that at least part of the battery cell is spaced apart from the exterior member by a given distance to form a first gap; and
forming a foamed resin fixing member between the battery cell and the exterior member by injecting a foamed resin having self-adhesiveness into part of the first gap, and bonding and solidifying the foamed resin.

10. The manufacturing method according to claim 9, wherein
the exterior member is capable of accommodating a plurality of battery cells in lamination,
the holding comprises holding the battery cells in such a manner that one of the battery cells is at least partially spaced apart from at least part of another one of the battery cells by a given distance to form a second gap, and
the forming comprises forming a foamed resin fixing member between the one of the battery cells and the another one of the battery cells by injecting a foamed resin having self-adhesiveness into part of the second gap, and bonding and solidifying the foamed resin.
